(19) United States
(12) Patent Application Publication
(10) Pub. No.: US 2025/0250142 A1
(43) Pub. Date: Aug. 7, 2025

(54) BRAKE ASSEMBLY FOR A PNEUMATIC VACUUM ELEVATOR AND METHOD TO OPERATE THE SAME

(71) Applicant: KILLAKATHU RAMANATHAN BABU, CHENNAI, TAMILNADU (IN)

(72) Inventor: KILLAKATHU RAMANATHAN BABU, CHENNAI, TAMILNADU (IN)

(21) Appl. No.: 17/928,340

(22) PCT Filed: Sep. 11, 2020
(86) PCT No.: PCT/IB2020/058456

§ 371 Date: Nov. 29, 2022

(30) Foreign Application Priority Data
Jun. 2, 2020 (IN) 202041023091

(51) Int. Cl. B66B 5/18; B66B 1/36; B66B 9/04

(52) U.S. Cl. CPC B66B 5/18; B66B 1/365; B66B 9/04

(57) ABSTRACT

A brake assembly for a pneumatic vacuum elevator is disclosed. The brake assembly includes a support plate mechanically coupled to a brake fixing plate fixed on an elevator cabin. The brake assembly also includes a brake wheel coupled to the support plate. The support plate is configured to rotate based on movement of the brake wheel. The brake assembly further includes at least one spring coupled to a seal assembly and the brake fixing plate, wherein the spring is actuated based on the movement of the seal assembly. The brake assembly further includes a plurality of brake shoes coupled to the support plate. The plurality of brake shoes is configured to control the movement of the elevator cabin in at least one mode via a guide rail based on the movement of the at least one spring and the brake wheel.

### CROSS-REFERENCE TO RELATED APPLICATION

This Application claims priority from a Patent application filed in India having Patent Application No. 202041023091, filed on Jun. 2, 2020, and titled “BRAKE ASSEMBLY FOR A PNEUMATIC VACUUM ELEVATOR AND METHOD TO OPERATE THE SAME” and a PCT Application No. PCT/IB2020/058456 filed on Sep. 11, 2020, and titled “BRAKE ASSEMBLY FOR A PNEUMATIC VACUUM ELEVATOR AND METHOD TO OPERATE THE SAME”.

### BACKGROUND

Embodiment of the present disclosure relates to a pneumatic vacuum elevator, and more particularly to, a brake assembly for a pneumatic vacuum elevator and a method to operate the same.

An elevator is a means of transporting a passenger or an object on a cage installed in a hoist way formed inside a building to smooth the movement between the floors. The elevator includes various parts; however, brakes are an extremely important safety feature. The elevator has different brakes designed for different purposes. One example is the machinery brake which is used to hold the elevator cabin in place during the elevator idle time. The machinery brake may also be used as an emergency brake in certain situations. For example, if a safety contact opens in the elevator safety chain, or during a power failure, the machinery brake is engaged and it can be operated manually by a brake lever, wherein the elevator car may be lowered to a desired position close to a door at a floor level. The machinery brake may also be used for stopping the elevator car for longer periods, for example during maintenance.

Conventional designs apply a manual lever that is connected to the brake by a single wire. The brake is engaged by releasing the lever, wherein the springs arranged to the brake assembly push the brake pads. The brake is released by pulling the brake lever, wherein the springs are tensioned for example to pull the brake pads off the braking surface. However, problems of such conventional designs include high friction of the brake release mechanism that may relate to insufficient maintenance, faulty material, installation errors or a long brake wire.

Furthermore, Current technologies employ a set of teeth or brail-like protrusions on the surface of the brake; these are specifically designed to retard the descent of the cabin or vehicle as needed. Even though there are other brakes in the market all of these require electrical power, a slot to anchor the brake to, a tensioned cable from the controls, and or an electrical sensor to activate.

Hence, there is a need for an improved brake assembly for pneumatic vacuum elevator to address the aforementioned issue(s).

### BRIEF DESCRIPTION

In accordance with an embodiment of the present disclosure, a brake assembly for a pneumatic vacuum elevator is provided. The brake assembly includes a support plate mechanically coupled to a brake fixing plate fixed on an elevator cabin. The brake assembly also includes a brake wheel coupled to the support plate. The support plate is configured to rotate based on movement of the brake wheel. The brake assembly further includes at least one spring coupled to a seal assembly and the brake fixing plate, wherein the spring is actuated based on the movement of the seal assembly. The brake assembly further includes a plurality of brake shoes coupled to the support plate. The plurality of brake shoes is configured to control the movement of the elevator cabin in at least one mode via a guide rail based on the movement of the at least one spring and the brake wheel.

In accordance with another embodiment of the present disclosure, a method for operating the brake assembly of the pneumatic vacuum elevator is provided. The method includes moving a seal assembly in a first predefined direction corresponding to at least one mode using tension of at least one spring. The method also includes moving a brake wheel in a second predefined direction by touching a seal plate of the seal assembly based on the movement of the seal assembly. The method further includes operating a plurality of brake shoes in at least one mode based on the movement of the brake wheel to control the movement of the elevator cabin.

In accordance with yet another embodiment of the present disclosure, a pneumatic vacuum elevator is provided. The elevator includes an elevator cabin configured to carry one or more users between one or more levels of a structure. The elevator also includes a brake assembly including a support plate mechanically coupled to a brake fixing plate fixed on an elevator cabin. The brake assembly also includes a brake wheel coupled to the support plate. The support plate is configured to rotate based on movement of the brake wheel. The brake assembly further includes at least one spring coupled to a seal assembly and the brake fixing plate. The spring is actuated based on the movement of the seal assembly. The brake assembly further includes a plurality of brake shoes coupled to the support plate. The plurality of brake shoes is configured to control the movement of the elevator cabin in at least one mode via a guide rail based on the movement of the at least one spring and the brake wheel.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a brake assembly of a pneumatic vacuum elevator in accordance with an embodiment of the present disclosure;

FIG. 2 is a schematic representation of an exploded view of brake assembly of FIG. 1, depicting position of various components in the brake assembly in accordance with an embodiment of the present disclosure;

FIG. 3 is a schematic representation of one embodiment of the brake assembly of FIG. 1 in accordance with an embodiment of the present disclosure. The grip plate weldment is one part of the brake assembly;

FIG. 4 is a schematic representation of another embodiment of the brake assembly of FIG. 1 in accordance with an embodiment of the present disclosure. The support plate is one part of brake assembly;

FIG. 5 is a schematic representation of functional view of the brake assembly of FIG. 1, depicting the operation of the brake assembly in vacuum mode in accordance with an embodiment of the present disclosure;

FIG. 6 is a schematic representation of functional view of the brake assembly of FIG. 1, depicting the operation of the brake assembly in no vacuum mode in accordance with an embodiment of the present disclosure;

FIG. 7 is a schematic representation of functional view of the brake assembly of FIG. 1, depicting operation of emergency braking system in two conditions in accordance with an embodiment of the present disclosure

FIG. 8 is a schematic representation of pneumatic vacuum elevator in accordance with an embodiment of the present disclosure; and

FIG. 9 is a flow chart representing the steps involved in a method for operating the brake assembly of the pneumatic vacuum elevator in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to the brake assembly of the pneumatic vacuum elevator and method to operate the same. The brake assembly includes a support plate mechanically coupled to a brake fixing plate fixed on an elevator cabin. The brake assembly also includes a brake wheel coupled to the support plate. The support is plate is configured to rotate based on movement of the brake wheel. The brake assembly further includes at least one spring coupled to a seal assembly and the brake fixing plate, wherein the spring is actuated based on the movement of the seal assembly. The brake assembly further includes a plurality of brake shoes coupled to the support plate, wherein the set of brake shoes is configured to control the movement of the elevator cabin in at least one mode via a guide rail based on the movement of the at least one spring and the brake wheel.

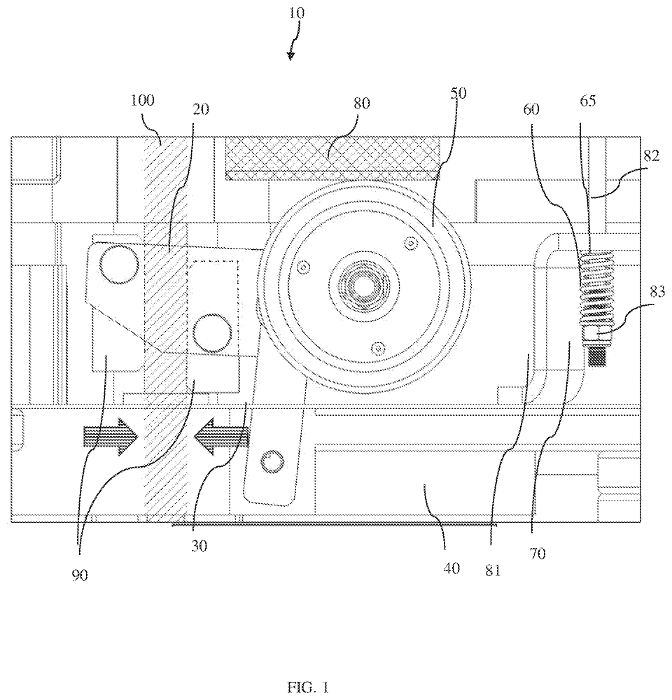

FIG. 1 is a schematic representation of a brake assembly 10 of a pneumatic vacuum elevator in accordance with an embodiment of the present disclosure. The brake assembly 10 includes a support plate 20 mechanically coupled to a brake fixing plate 30. The brake fixing plate 30 is fixed on an elevator cabin 40. As used herein, the elevator cabin moves people or freight between floors, levels, or decks of a building, vessel, or other structures. The brake assembly 10 also includes a brake wheel 50 mechanically coupled to the support plate 20. The support plate 20 rotates when the brake wheel 50 moves under certain conditions. In a specific embodiment, the brake wheel 50 may include a rubber brake wheel.

Furthermore, the brake assembly 10 includes at least one spring 60. The at least one spring 60 includes a first end 65 and a second end 70. The first end 65 of the at least one spring 60 is mechanically coupled to a seal assembly 80. As used herein, the seal assembly allows an almost frictionless movement and hoists the elevator cabin due to the pneumatic depression generated on the upper part of the elevator cabin. Further, the second end 70 of the at least one spring 60 is mechanically coupled to the brake fixing plate 30. The movement of the seal assembly 80 due to pressure on the elevator cabin 40 may result in actuation of the at least one spring 60. In one embodiment, the seal assembly 80 is coupled with the elevator cabin 40 via a seal resting channel 81 with the hex bolt 82, the at least one spring 60 and the locknut 83.

The brake assembly 10 further includes brake shoes 90 which is mechanically coupled to the support plate 20. In an exemplary embodiment, the brake shoes 90 may include a pair of brake shoes. In one embodiment, the brake shoes 90 may be composed of metal. The brake shoes 90 control the movement of the elevator cabin 40 in at least one mode via a guide rail 100 based on the movement of the at least one spring 60 and the brake wheel 50. In one embodiment, the at least one mode may include a vacuum mode. In another embodiment, the at least one mode may include a no vacuum mode. In one embodiment, the guide rail 100 is a pillar and may be composed of aluminum material. In details, the movement of the at least one spring 60 results in the movement of the brake wheel 50, where brake wheel 50 is mechanically coupled to the support plate 20 which also rotates when the brake wheel 50 moves. The movement of the support plate 20 results in movement of the brake shoes 90 which are coupled to the support plate 20. Hence, the brake shoes 90 either hold the elevator cabin 40 or release the elevator cabin 40 depending upon the at least one mode of the operation.

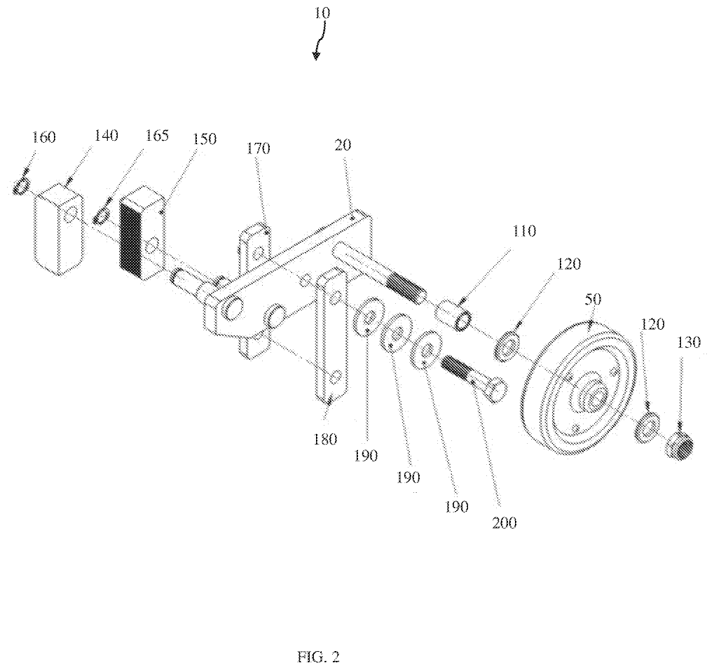

FIG. 2 is a schematic representation of an exploded view of brake assembly 10 of FIG. 1, depicting position of various components in the brake assembly 10 in accordance with an embodiment of the present disclosure. The brake assembly 10 includes the support plate 20 which is coupled to the brake fixing plate 30. In one embodiment, the brake fixing plate 30 is fixed on a roof sheet of the elevator cabin 40 using a set of hex bolts (not shown in FIG. 2), washer and guiding with the guide rail 100. Further, the brake assembly 100 includes the brake wheel 50. In some embodiments, the brake wheel 50 touches the seal assembly 80 in the elevator cabin 40 using a first spacer (not shown in FIG. 2). In one embodiment, the brake wheel 50 is coupled to the support plate 20 using a second spacer 110 and at least two plated washers 120 by using a locknut 130. In such an embodiment, the locknut 130 may include a hex nyloc nut. As used herein, the nyloc nut may include a nylon-insert lock nut, polymer-insert lock nut, or elastic stop nut. The nyloc nut is a kind of locknut with a nylon collar that increases friction on the screw thread.

Furthermore, the brake assembly 10 includes the brake shoes 90. The brake shoes 90 include a first brake shoe 140 and a second brake shoe 150. In one embodiment, the first brake shoe 140 and the second brake shoe 150 are coupled to the support plate 20 using at least two retaining rings 160, 165. The first brake shoe 140 is coupled to support plate 20 using one retaining ring 160 from the at least two retaining rings and the second brake shoe 150 is coupled to the support plate 20 using another retaining ring 165 from the at least two retaining rings. In such an embodiment, the at least two retaining rings 160, 165 may be at least two circlip (a portmanteau of “circle” and “clip”), also known as a C-clip or snap ring. The circlip is a type of fastener or retaining ring includes a semi-flexible metal ring with open ends which may be snapped into place.

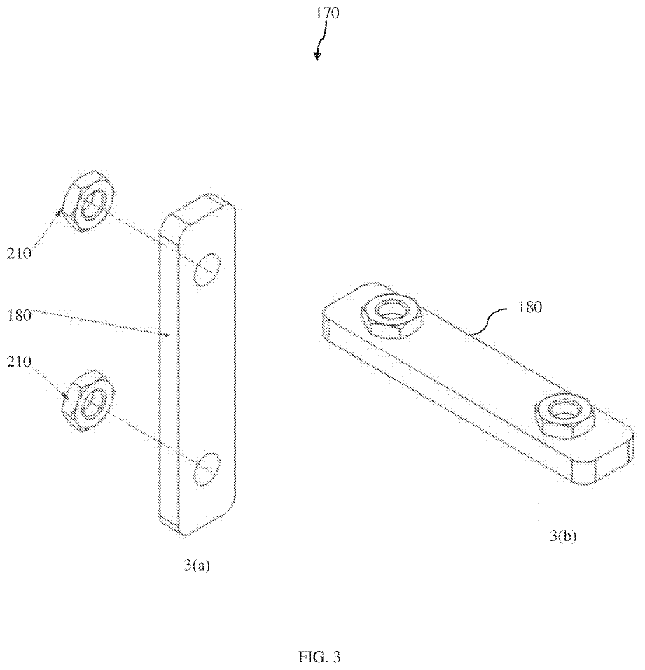

In addition, the support plate 20 is coupled to a grip plate weldment 170 and a grip plate 180 using at least three plated washers 190 and a hex bolt 200. The grip plate 180 includes two ends, one end is connected with the elevator cabin 40 inside an elevator cylinder, another end is connected with support plate 20 of the brake assembly. One embodiment of the grip plate 180 is shown in FIG. 3.

FIG. 3 is a schematic representation of one embodiment of the brake assembly of FIG. 1 in accordance with an embodiment of the present disclosure. The grip plate weldment 170 is one part of the brake assembly 10. FIG. 3a shows an exploded view of grip plate weldment 170 with aligning position, and FIG. 3b shows an assembled view of grip plate weldment 170 with fixing position. The grip plate 180 is the main part of grip plate weldment 170 and the two hex nuts 210 are welded with grip plate 180 which are used to connect with the elevator cabin 40. The grip plate 180 includes two ends, one end is connected with the elevator cabin 140 inside an elevator cylinder, another end is connected with support plate 20 of the brake assembly 10.

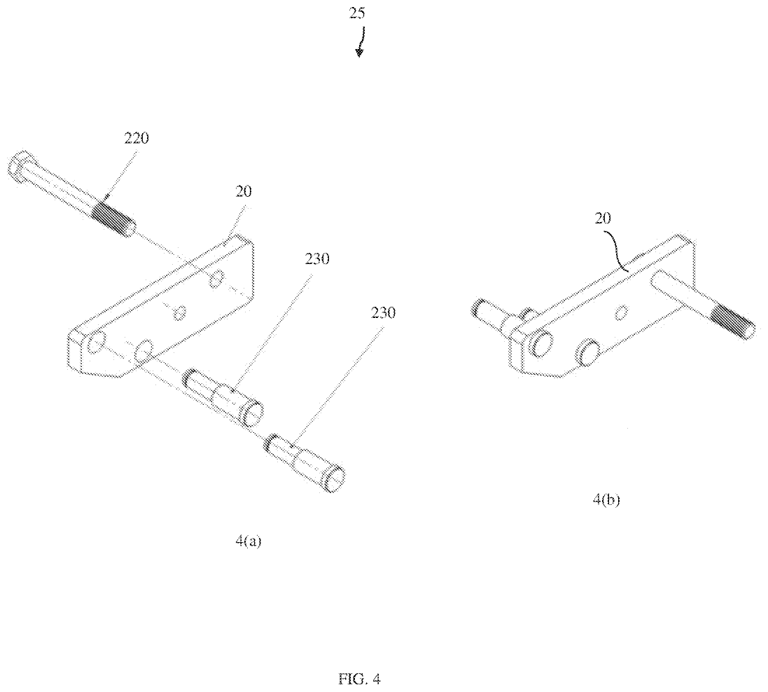

FIG. 4 is a schematic representation of another embodiment 25 of the brake assembly of FIG. 1 in accordance with an embodiment of the present disclosure. The support plate 20 is one part of brake assembly 10. FIG. 4(a) shows an exploded view of support plate 20 with aligning position, and FIG. 4(b) shows an assembled view of support plate 20 with fixing position The support plate 20 is the main component of the brake assembly 10 to which the hex bolt 220 is welded to fix brake wheel 50. Also, the two guide pins 230 are welded with support plate 20 used for fixing the brake shoes 90.

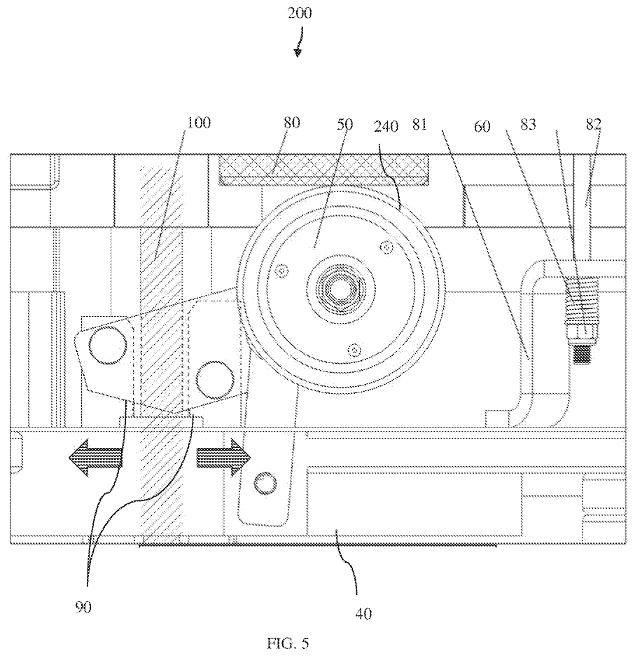

FIG. 5 is a schematic representation of functional view of the brake assembly 10 of FIG. 1, depicting the operation of the brake assembly 10 in vacuum mode in accordance with an embodiment of the present disclosure. During more vacuum condition, the seal assembly 80 is connected with seal resting channel 81, which is welded at the elevator cabin 40 with hex bolt 82, the at least one spring 60 and the locknut 83. When there is more vacuum in the elevator, the seal assembly 80 is lifting upper side with help of compression of the at least one spring 60. Consequently, the brake wheel 50 is moved upper side along with touching the bottom of a seal plate 240 of the seal assembly 80. As a result, the brake is released, more specifically, the two brake shoes 90 do not touch with the guide rail 100 in a vacuum cylinder assembly and the elevator cabin 40 is free for movement from one level to another in any direction.

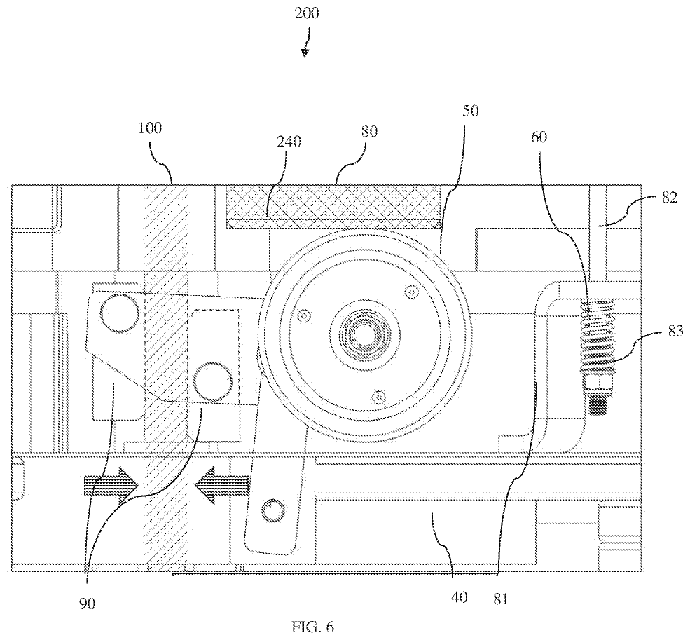

FIG. 6 is a schematic representation of functional view of the brake assembly of FIG. 1, depicting the operation of the brake assembly in no vacuum mode in accordance with an embodiment of the present disclosure. During no vacuum condition, the seal assembly is connected with seal resting channel 81, which is welded at the elevator cabin 40 with hex bolt 82, the at least one spring 60 and the locknut 83. When there is no vacuum in the elevator, the seal assembly 80 is lifting downside with help of tension of the at least one spring 60 Consequently, the brake wheel 50 is moved lower side along with touching the bottom of a seal plate 240 of the seal assembly 80. As a result, the brake is applied, more specifically, the two brake shoes 90 hold the guide rail 100 in a vacuum cylinder assembly and restricts the movement of the elevator cabin 40 in any direction.

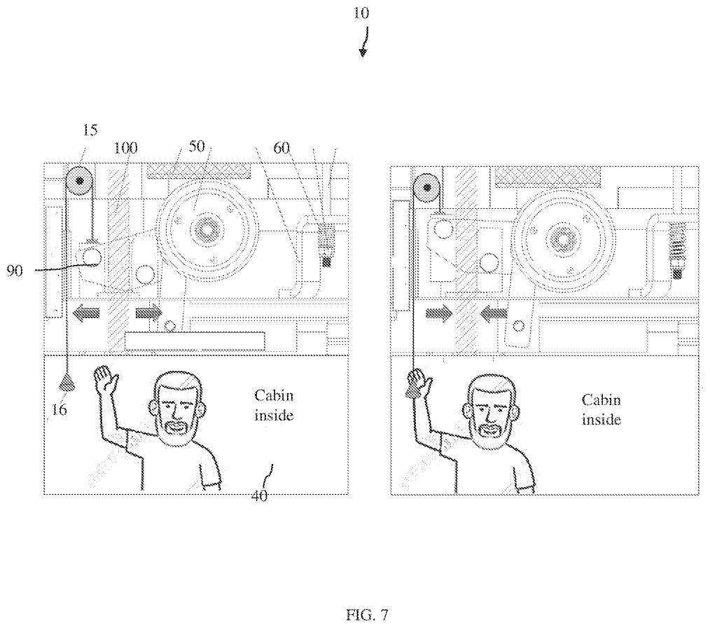

FIG. 7 is a schematic representation of functional view of the brake assembly 10 of FIG. 1, depicting operation of emergency braking system in two conditions in accordance with an embodiment of the present disclosure. The brake assembly includes an emergency braking system 15 including a brake handle, a brake lever, a push button, a switch, an overpaid governor or any triggering device. In one exemplary embodiment, the emergency braking system with a brake lever 16 is located inside the elevator cabin 40 and coupled with the plurality of brake shoes 90. The brake lever 16 may be pulled by person inside the elevator cabin 40. The brake lever 16 is coupled with break assembly through connected with the brake shoes 90 which may grasp the guide rail 100. The brake lever 16 is configured to stop the movement of the elevator cabin 40 in a running condition. During cabin movement, in case it is required to suddenly stop the cabin, a person inside the elevator cabin 40 may pull the brake lever 16 which is located at the top of the person head and the brake lever 16 is reachable to hand level inside the elevator cabin 40. Upon pulling the brake lever 16, the brake shoes 90 grasps a guide rail 100 in a vacuum cylinder assembly.

In a specific embodiment, the brake assembly 10 may include a brake release system inside the bottom of the elevator cabin 40 or also outside the shaft in the ground floor of the structure. In detail, when the brake release system is activated, the motors are started and pulls the elevator in upwards direction and during such course of movement, the brakes get released. In another embodiment, when the brakes are activated, the motors are turned off and the brakes are applied.

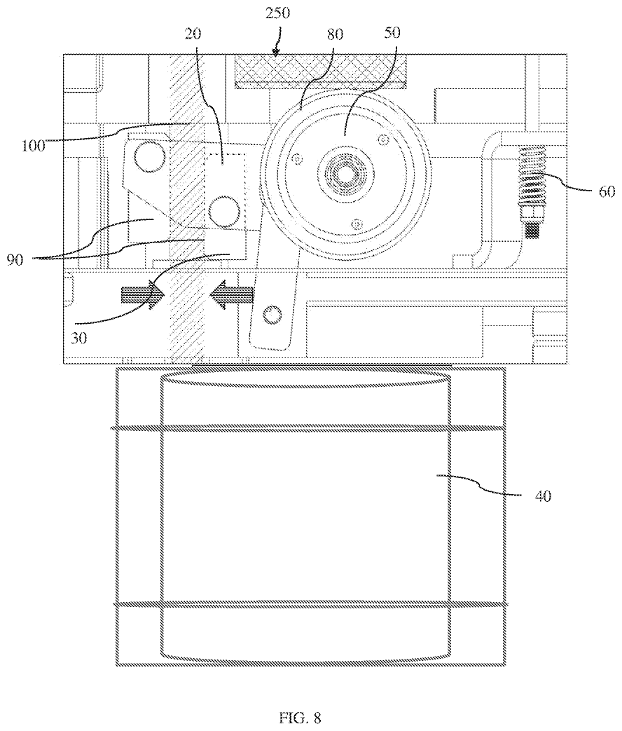

FIG. 8 is a schematic representation of pneumatic vacuum elevator 250 in accordance with an embodiment of the present disclosure. The elevator 250 includes an elevator cabin 40 to carry one or more users between one or more levels of a structure. In one embodiment, the structure may include building, vessel or the like. The elevator 250 also includes a brake assembly 10. The brake assembly 10 includes a support plate 20 mechanically coupled to a brake fixing plate 30 fixed on the elevator cabin 40. The brake assembly 10 also includes a brake wheel 50 coupled to the support plate 20. The support plate 20 rotates based on movement of the brake wheel 50. The brake assembly 10 further includes at least one spring 60 coupled to a seal assembly 80 and the brake fixing plate 30. The spring 60 is actuated based on the movement of the seal assembly 80. The brake assembly 10 further includes brake shoes 90 coupled to the support plate 20. The brake shoes 90 controls the movement of the elevator cabin 40 in at least one mode via a guide rail 100 based on the movement of the at least one spring 60 and the brake wheel 50.

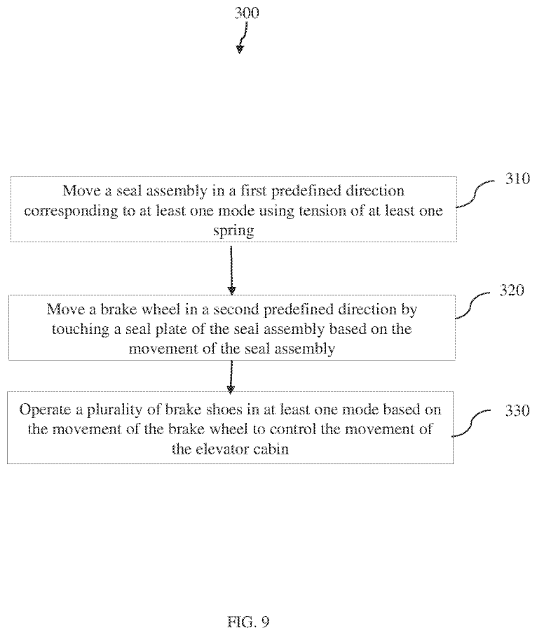

FIG. 9 is a flow chart representing the steps involved in a method 300 for operating the brake assembly of the pneumatic vacuum elevator in accordance with an embodiment of the present disclosure. The method 300 includes moving a seal assembly in a first predefined direction corresponding to at least one mode using tension of at least one spring in step 310. In one embodiment, moving the seal assembly may include moving the seal assembly in downward direction using tension of the at least one spring in case of no vacuum condition. In another embodiment, moving the seal assembly may include moving the seal assembly in upward direction using the tension of the at least one spring in case of more vacuum condition.

The method 300 also includes moving a brake wheel in a second predefined direction by touching a seal plate of the seal assembly based on the movement of the seal assembly in step 320. In one embodiment, moving the brake wheel may include moving the brake wheel in lower side based on the downward direction movement of the seal assembly. In another embodiment, moving the brake wheel may include moving the brake wheel in upper side based on the upward direction movement of the seal assembly.

Additionally, the method 300 includes operating a plurality of brake shoes in at least one mode based on the movement of the brake wheel to control the movement of the elevator cabin in step 330. In one embodiment, operating the plurality of brake shoes may include releasing the set of brake shoes from a guide rail in a cylinder assembly based on the movement of the brake wheel in a vacuum mode. In another embodiment, operating the plurality of brake shoe may include holding the guide rail by the set of brake shoes in the cylinder assembly based on the movement of the brake wheel in a no vacuum mode.

Various embodiments of the brake assembly as described above enables smooth operation of the brake assembly of the pneumatic vacuum elevator even in the event of a sudden loss of vacuum or any other incident that may lead to an uncontrollable descent of the elevator cabin in its cylindrical guideway. Due to the mechanical design, no electrical power is required to break the transport cabin or vehicle. Similarly, a sudden loss of power would not cause the cabin or vehicle to break or stop between floors thereby reducing system malfunctions that occur in other systems.

In the event that the elevator suddenly loses vacuum, the seal assembly returns to its original position. Such condition removes the force being acted on the compression spring causing the brakes to close and stopping the downward motion of the elevator cabin. Hence, this action stops an uncontrolled descent of the cabin.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method 250 in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A brake assembly for a pneumatic vacuum elevator comprising:
a support plate mechanically coupled to a brake fixing plate fixed on an elevator cabin;
a brake wheel coupled to the support plate, wherein the support plate is configured to rotate based on movement of the brake wheel;
at least one spring coupled to a seal assembly and the brake fixing plate, wherein the at least one spring is actuated based on the movement of the seal assembly; and
a plurality of brake shoes coupled to the support plate, wherein the plurality of brake shoes is configured to control the movement of the elevator cabin in at least one mode via a guide rail based on the movement of the at least one spring and the brake wheel.

2. The brake assembly as claimed in claim 1, wherein the brake fixing plate is fixed with the elevator cabin using a set of hex bolts and a washer and guiding with the guide rail.

3. The brake assembly as claimed in claim 1, wherein the plurality of brake shoes 90 is coupled to the support plate using at least two retaining rings.

4. The brake assembly as claimed in claim 1, wherein the support plate is coupled to a grip plate weldment and a grip plate using at least three plated washers and a hex bolt.

5. The break assembly as claimed in claim 1, comprising an emergency braking system comprises a brake handle, a brake lever, a push button, a switch, an overpaid governor or a triggering device.

6. The brake assembly as claimed in claim 1, wherein the seal assembly is coupled with the elevator cabin via a seal resting channel with the hex bolt, the at least one spring and the locknut.

7. A method comprising:
moving a seal assembly in a first predefined direction corresponding to at least one mode using tension of at least one spring;
moving a brake wheel in a second predefined direction by touching a seal plate of the seal assembly based on the movement of the seal assembly; and
operating a plurality of brake shoes in at least one mode based on the movement of the brake wheel to control the movement of the elevator cabin.

8. The method as claimed in claim 7, wherein operating the plurality of brake shoes comprises releasing the set of brake shoes from a guide rail in a cylinder assembly based on the movement of the brake wheel in a vacuum mode.

9. The method as claimed in claim 7, wherein operating the plurality of brake shoe comprises holding the guide rail by the set of brake shoes in the cylinder assembly based on the movement of the brake wheel in a no vacuum mode.

10. A pneumatic vacuum elevator comprising:
an elevator cabin configured to carry one or more users between one or more levels of a structure; and
a brake assembly mechanically coupled to the elevator cabin, wherein the brake assembly comprises:
a support plate mechanically coupled to a brake fixing plate fixed on the elevator cabin;
a brake wheel coupled to the support plate, wherein the support plate is configured to rotate based on movement of the brake wheel;
at least one spring coupled to a seal assembly and the brake fixing plate, wherein the at least one spring is actuated based on the movement of the seal assembly; and
a plurality of brake shoes coupled to the support plate, wherein the plurality of brake shoes is configured to control the movement of the elevator cabin in at least one mode via a guide rail based on the movement of the at least one spring and the brake wheel.
